(19) United States
(12) Patent Application Publication
(10) Pub. No.: US 2025/0203544 A1
(43) Pub. Date: Jun. 19, 2025

(54) COMMON ENERGY SIGNAL CONFIGURATIONS

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Yuchul KIM, San Diego, CA (US); Huilin XU, Temecula, CA (US); Zhikun WU, Beijing (CN); Linhai HE, San Diego, CA (US); Wanshi CHEN, San Diego, CA (US); Peter GAAL, San Diego, CA (US)

(21) Appl. No.: 18/849,379

(22) PCT Filed: May 27, 2022
(86) PCT No.: PCT/CN2022/095451

§ 371 Date: Sep. 20, 2024

(51) Int. Cl. H04W 56/00; H04W 16/28; H04W 24/10

(52) U.S. Cl. CPC H04W 56/0015; H04W 16/28; H04W 24/10

(57) ABSTRACT

Methods, systems, and devices for wireless communications are described. A user equipment (UE) may identify common or UE-specific energy transfer resources that the UE may monitor for energy transfer signals. The UE may identify such energy transfer resources based on a mapping between synchronization signal block (SSB) indices and the energy transfer resources. The mapping may be a one-to-one mapping, or a one-to-many mapping. In a one-to-many mapping, subsets of each mapped set of energy transfer resources may correspond to different energy harvesting types, different energy charging rates, or different periodicities or power settings, among other examples. The mapping may be included in one or more standards documents, or may be configured at the UE via system information, control signaling, random access messages, or a combination thereof.

### CROSS REFERENCE

The present application is a 371 national phase filing of International PCT Application No. PCT/CN2022/095451 by ELSHAFIE et al., entitled “COMMON ENERGY SIGNAL CONFIGURATIONS,” filed May 27, 2022, which is assigned to the assignee hereof, and which is expressly incorporated by reference in its entirety herein.

### TECHNICAL FIELD

The following relates to wireless communications, including common energy signal configurations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support common energy signal configurations. For example, a user equipment (UE) may identify common or UE-specific energy transfer resources that the UE may monitor for energy transfer signals. The UE may identify such energy transfer resources based on a mapping between synchronization signal block (SSB) indices and the energy transfer resources. The mapping may be a one-to-one mapping, or a one-to-many mapping. In a one-to-many mapping, subsets of each mapped set of energy transfer resources may correspond to different energy harvesting types, different energy charging rates, or different periodicities or power settings, among other examples. The mapping may be included in one or more standards documents, or may be configured at the UE via system information, control signaling, random access messages, or a combination thereof. In some examples, the network may provide the UE with parameters for the waveforms of the energy transfer signals, so that the UE can cancel them out in the case of the UE also receiving data signaling on the same resources.

A method for wireless communications at a user equipment (UE) is described. The method may include receiving a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources, monitoring a set of one or more energy transfer resources for one or more energy transfer signals, the set of one or more energy transfer resources corresponding to a first SSB of the set of multiple SSBs according to the mapping, and performing energy harvesting using the one or more energy transfer signals.

An apparatus for wireless communications at a UE is described. The apparatus may include at least one processor, memory coupled to the at least one processor, and instructions stored in the memory. The instructions may be executable by the processor to cause the UE to receive a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources, monitor a set of one or more energy transfer resources for one or more energy transfer signals, the set of one or more energy transfer resources corresponding to a first SSB of the set of multiple SSBs according to the mapping, and perform energy harvesting using the one or more energy transfer signals.

Another apparatus for wireless communications at a UE is described. The apparatus may include means for receiving a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources, means for monitoring a set of one or more energy transfer resources for one or more energy transfer signals, the set of one or more energy transfer resources corresponding to a first SSB of the set of multiple SSBs according to the mapping, and means for performing energy harvesting using the one or more energy transfer signals.

A non-transitory computer-readable medium storing code for wireless communications at a UE is described. The code may include instructions executable by at least one processor to receive a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources, monitor a set of one or more energy transfer resources for one or more energy transfer signals, the set of one or more energy transfer resources corresponding to a first SSB of the set of multiple SSBs according to the mapping, and perform energy harvesting using the one or more energy transfer signals.

Some examples of the method, apparatuses, and non-transitory computer-readable medium described herein may further include operations, features, means, or instructions for receiving, based on the monitoring, the one or more energy transfer signals using a spatial filter that may be associated with the set of one or more energy transfer resources according to a further mapping between the spatial filter and the set of one or more energy transfer resources, where the spatial filter may be not associated with a first transmission beam corresponding to the first SSB.

Some examples of the method, apparatuses, and non-transitory computer-readable medium described herein may further include operations, features, means, or instructions for receiving, based on the monitoring, the one or more energy transfer signals using a spatial filter that may be associated with a first transmission beam corresponding to the first SSB according to a further mapping between the first transmission beam corresponding to the first SSB and the set of one or more energy transfer resources.

Some examples of the method, apparatuses, and non-transitory computer-readable medium described herein may further include operations, features, means, or instructions for receiving an indication that the UE refrain from transmitting a measurement report associated with the one or more energy transfer signals, where the one or more energy transfer signals include reference signals that may be quasi co-located with a transmission beam of the set of multiple respective transmission beams that may be associated with the first SSB.

Some examples of the method, apparatuses, and non-transitory computer-readable medium described herein may further include operations, features, means, or instructions for selecting a first subset of the set of one or more energy transfer resources based on an energy transfer type of the UE, where each subset of a set of multiple subsets of the set of one or more energy transfer resources may be associated with a respective energy transfer type of a set of multiple energy transfer types.

In some examples of the method, apparatuses, and non-transitory computer-readable medium described herein, each subset of the set of multiple subsets of the set of one or more energy transfer resources may be associated with a respective energy transfer charging rate.

In some examples of the method, apparatuses, and non-transitory computer-readable medium described herein, each subset of the set of multiple subsets of the set of one or more energy transfer resources may be associated with a respective type of energy harvesting, a respective set of frequency resources, a respective periodicity, a respective UE power setting, or any combination thereof.

Some examples of the method, apparatuses, and non-transitory computer-readable medium described herein may further include operations, features, means, or instructions for receiving system information, master information, or a random access message, including an indication of the mapping.

Some examples of the method, apparatuses, and non-transitory computer-readable medium described herein may further include operations, features, means, or instructions for receiving control signaling indicating a second set of frequency resource associated with a second set of one or more energy transfer resources.

Some examples of the method, apparatuses, and non-transitory computer-readable medium described herein may further include operations, features, means, or instructions for tuning energy harvesting circuitry at the UE to the first set of frequency resources associated with the set of one or more energy transfer resources, where performing the energy harvesting may be based on the tuning and retuning to the second set of one or more energy transfer resources according to the control signaling.

Some examples of the method, apparatuses, and non-transitory computer-readable medium described herein may further include operations, features, means, or instructions for receiving an indication of a second set of one or more energy transfer resources, where the set of one or more energy transfer resources may be associated with a first set of transmission beams and the second set of one or more energy transfer resources may be associated with a second set of transmission beams, and where the second set of transmission beams may be more narrow than the first set of transmission beams, monitoring for one or more additional energy transfer signals using the second set of one or more energy transfer resources over the second set of transmission beams, and performing energy harvesting using the one or more additional energy transfer signals.

Some examples of the method, apparatuses, and non-transitory computer-readable medium described herein may further include operations, features, means, or instructions for receiving an indication of one or more parameters associated with the one or more energy transfer signals, monitoring for data transmissions during at least a portion of the set of one or more energy transfer resources, canceling the one or more energy transfer signals based on the one or more parameters, and decoding the data transmissions based on the canceling.

A method for wireless communications at a network entity is described. The method may include outputting a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources and outputting one or more energy transfer signals on a set of one or more energy transfer resources, the set of one or more energy transfer resources corresponding to a first SSB of the set of multiple SSBs according to the mapping.

An apparatus for wireless communications at a network entity is described. The apparatus may include at least one processor, memory coupled with the at least one processor, and instructions stored in the memory. The instructions may be executable by the at least one processor to cause the apparatus to output a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources and output one or more energy transfer signals on a set of one or more energy transfer resources, the set of one or more energy transfer resources corresponding to a first SSB of the set of multiple SSBs according to the mapping.

Another apparatus for wireless communications at a network entity is described. The apparatus may include means for outputting a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources and means for outputting one or more energy transfer signals on a set of one or more energy transfer resources, the set of one or more energy transfer resources corresponding to a first SSB of the set of multiple SSBs according to the mapping.

A non-transitory computer-readable medium storing code for wireless communications at a network entity is described. The code may include instructions executable by at least one processor to output a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources and output one or more energy transfer signals on a set of one or more energy transfer resources, the set of one or more energy transfer resources corresponding to a first SSB of the set of multiple SSBs according to the mapping.

Some examples of the method, apparatuses, and non-transitory computer-readable medium described herein may further include operations, features, means, or instructions for outputting the one or more energy transfer signals using a transmission beam that may be associated with the set of one or more energy transfer resources according to a further mapping between the transmission beam and the set of one or more energy transfer resources, where the transmission beam may be not associated with a first transmission beam of the set of multiple transmission beams corresponding to the first SSB.

Some examples of the method, apparatuses, and non-transitory computer-readable medium described herein may further include operations, features, means, or instructions for outputting the one or more energy transfer signals using a first transmission beam of the set of multiple transmission beams that may be associated with the set of one or more energy transfer resources according to a further mapping between the first transmission beam and the set of one or more energy transfer resources, where the first SSB may be output using the first transmission beam.

Some examples of the method, apparatuses, and non-transitory computer-readable medium described herein may further include operations, features, means, or instructions for outputting an indication that a UE refrain from transmitting a measurement report associated with the one or more energy transfer signals, where the one or more energy transfer signals include reference signals that may be quasi co-located with a transmission beam of the set of multiple respective transmission beams that may be associated with the first SSB.

In some examples of the method, apparatuses, and non-transitory computer-readable medium described herein, each subset of a set of multiple subsets of the set of one or more energy transfer resources may be associated with a respective energy transfer type of a set of multiple energy transfer types.

In some examples of the method, apparatuses, and non-transitory computer-readable medium described herein, each subset of a set of multiple subsets of the set of one or more energy transfer resources may be associated with a respective energy transfer charging rate.

In some examples of the method, apparatuses, and non-transitory computer-readable medium described herein, each subset of a set of multiple subsets of the set of one or more energy transfer resources may be associated with a respective type of energy harvesting, a respective set of frequency resources, a respective periodicity, a respective UE power setting, or any combination thereof.

Some examples of the method, apparatuses, and non-transitory computer-readable medium described herein may further include operations, features, means, or instructions for outputting system information, master information, or a random access message, including an indication of the mapping.

Some examples of the method, apparatuses, and non-transitory computer-readable medium described herein may further include operations, features, means, or instructions for outputting control signaling indicating a second set of frequency resource associated with a second set of one or more energy transfer resources.

Some examples of the method, apparatuses, and non-transitory computer-readable medium described herein may further include operations, features, means, or instructions for outputting an indication of a second set of one or more energy transfer resources, where the set of one or more energy transfer resources may be associated with a first set of transmission beams and the second set of one or more energy transfer resources may be associated with a second set of transmission beams, and where the second set of transmission beams may be more narrow than the first set of transmission beams and outputting one or more additional energy transfer signals using the second set of one or more energy transfer resources over the second set of transmission beams.

Some examples of the method, apparatuses, and non-transitory computer-readable medium described herein may further include operations, features, means, or instructions for outputting an indication of one or more parameters associated with the one or more energy transfer signals and outputting data signaling on at least a portion of the set of one or more energy transfer resources based on outputting the indication of the one or more parameters.

### BRIEF DESCRIPTION OF THE DRAWINGS

FIG. 1 illustrates an example of a wireless communications system that supports common energy signal configurations in accordance with one or more aspects of the present disclosure.

FIG. 2 illustrates an example of a wireless communications system that supports common energy signal configurations in accordance with one or more aspects of the present disclosure.

FIG. 3 illustrates an example of an energy transfer resource scheme that supports common energy signal configurations in accordance with one or more aspects of the present disclosure.

FIG. 4 illustrates an example of an energy transfer resource scheme that supports common energy signal configurations in accordance with one or more aspects of the present disclosure.

FIG. 5 illustrates an example of a process flow that supports common energy signal configurations in accordance with one or more aspects of the present disclosure.

FIGS. 6 and 7 show block diagrams of devices that support common energy signal configurations in accordance with one or more aspects of the present disclosure.

FIG. 8 shows a block diagram of a communications manager that supports common energy signal configurations in accordance with one or more aspects of the present disclosure.

FIG. 9 shows a diagram of a system including a device that supports common energy signal configurations in accordance with one or more aspects of the present disclosure.

FIGS. 10 and 11 show block diagrams of devices that support common energy signal configurations in accordance with one or more aspects of the present disclosure.

FIG. 12 shows a block diagram of a communications manager that supports common energy signal configurations in accordance with one or more aspects of the present disclosure.

FIG. 13 shows a diagram of a system including a device that supports common energy signal configurations in accordance with one or more aspects of the present disclosure.

FIGS. 14 through 17 show flowcharts illustrating methods that support common energy signal configurations in accordance with one or more aspects of the present disclosure.

### DETAILED DESCRIPTION

A wireless communications system may support user equipments (UEs) that are capable of performing energy harvesting. Such UEs may be examples of passive UEs in an internet of things (IoT) deployment. In some examples, such UEs may be able to receive energy transfer signals. However, if a wireless communication system does not support mechanisms by which the UE may determine which resources on which to receive energy transfer signals, then the UE may not effectively or efficiently harvest energy, and may therefore be intermittently unavailable or unreliable for wireless communications over time, resulting in failed transmissions, increased system latency, reduced battery life at the UE, and reduced user experience.

In some examples, a UE may identify common or UE-specific energy transfer resources that the UE may monitor for energy transfer signals. The UE may identify such energy transfer resources based on a mapping between synchronization signal block (SSB) indices and the energy transfer resources. The mapping may be a one-to-one mapping, or a one-to-many mapping. In a one-to-many mapping, subsets of each mapped set of energy transfer resources may correspond to different energy harvesting types, different energy charging rates, or different periodicities or power settings, among other examples. The mapping may be included in one or more standards documents, or may be configured at the UE via system information, control signaling, random access messages, or a combination thereof. In some examples, the network may provide the UE with parameters for the waveforms of the energy transfer signals, so that the UE can cancel them out in the case of the UE also receiving data signaling on the same resources.

Aspects of the disclosure are initially described in the context of wireless communications systems. Aspects of the disclosure are further illustrated by and described with reference to wireless communications systems, energy transfer resource schemes, and process flows. Aspects of the disclosure are further illustrated by and described with reference to apparatus diagrams, system diagrams, and flowcharts that relate to common energy signal configurations.

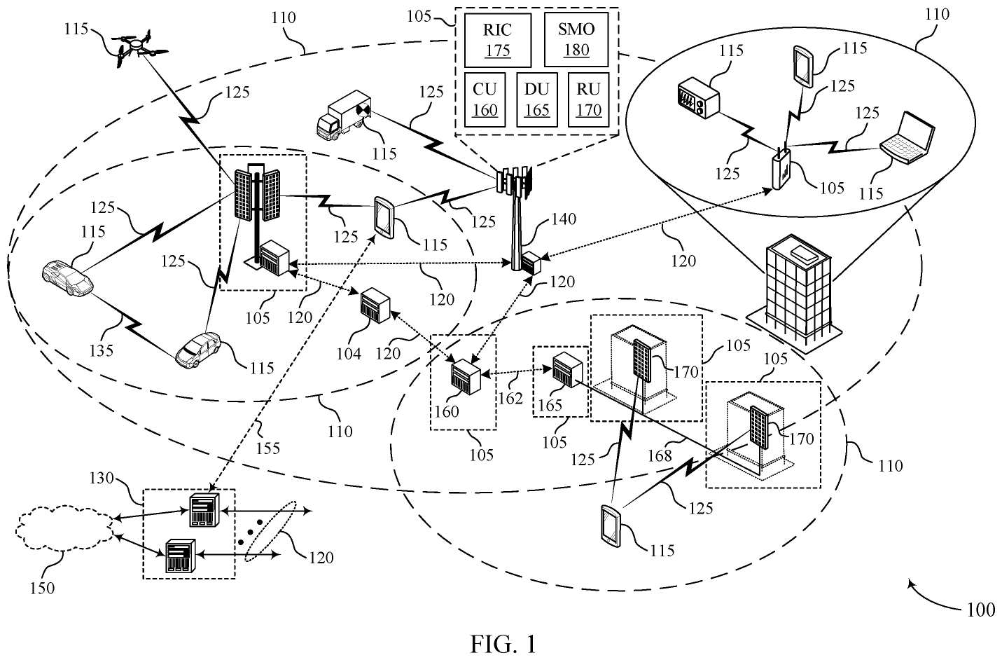

FIG. 1 illustrates an example of a wireless communications system 100 that supports common energy signal configurations in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, or computing system, may include disclosure of the UE 115, network entity 105, apparatus, device, or computing system, being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support common energy signal configurations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device, etc.), a camera, a gaming device, a navigation/positioning device (e.g., GNSS (global navigation satellite system) devices based on, for example, GPS (global positioning system), Beidou, GLONASS, or Galileo, or a terrestrial-based device, etc.), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), etc., and NB-IoT may include eNB-IoT (enhanced NB-IoT), and FeNB-IoT (further enhanced NB-IoT).

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, a UE 115 may identify common or UE-specific energy transfer resources that the UE 115 may monitor for energy transfer signals. The UE 115 may identify such energy transfer resources based on a mapping between synchronization signal block (SSB) indices and the energy transfer resources. The mapping may be a one-to-one mapping, or a one-to-many mapping. In a one-to-many mapping, subsets of each mapped set of energy transfer resources may correspond to different energy harvesting types, different energy charging rates, or different periodicities or power settings, among other examples. The mapping may be included in one or more standards documents, or may be configured at the UE 115 via system information, control signaling, random access messages, or a combination thereof. In some examples, the network may provide the UE 115 with parameters for the waveforms of the energy transfer signals, so that the UE 115 can cancel them out in the case of the UE 115 also receiving data signaling on the same resources.

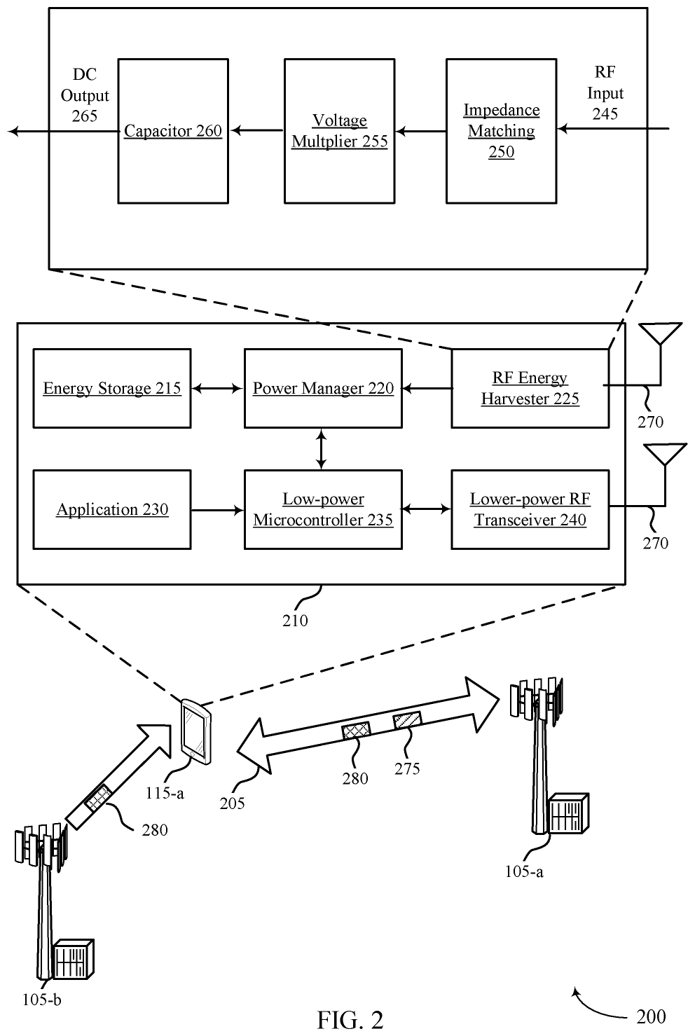

FIG. 2 illustrates an example of a wireless communications system 200 that supports common energy signal configurations in accordance with one or more aspects of the present disclosure. Wireless communications system 200 may include one or more UEs 115 (e.g., a UE 115-a) and one or more network entities 105 (e.g., a network entity 105-a and network entity 105-b), which may be examples of corresponding devices described with reference to FIG. 1.

The UE 115-a may be in communication with the network entity 105-a via bidirectional communication link 205. The UE 115-a may be an energy harvesting device (e.g., a reduced capacity (RedCap) UE), an enhanced RedCap (eRedCap) UE, a passive UE (PUE) in an IoT deployment, or a full capacity (e.g., non-RedCap) UE, among other examples. Energy harvesting devices, such as the UE 115-a, may opportunistically harvest energy from the environment. For example, the UE 115-a may harvest energy via backscattering, receiving energy transfer signaling from a network entity 105 (e.g., via a directional beam provided for the purpose of transferring energy to the UE 115-a), via solar energy transfer, heat energy transfer, ambient radio or frequency radiation. The UE 115-a may store such harvested energy (e.g., in a rechargeable battery). Some wireless communications systems may support energy harvesting protocols and energy handshake schemes. Such protocols may support operation (e.g., wireless communication) and energy harvesting on intermittently available energy harvested from the environment in which the UE 115-a is located. Variations in an amount of harvested energy for the UE 115-a may be expected over time, and in different scenarios (e.g., different traffic patterns for ambient radio frequency radiation, different times of day or night for solar energy harvesting, different charging capacity or rates at the UE 115-a, among other examples). Devices such as the UE 115-a operating on intermittently available energy harvested from the environment may not sustain long, or continuous reception or transmission operations.

The UE 115-a may be equipped with one or more power consuming radio frequency components such as ADC, mixers, or oscillators. The UE 115-a may support one or more transmit chains, and may tune transmit chains, energy harvesting circuitry, or both, to different frequency for wireless communications and energy harvesting. Energy harvesting wireless devices, such as the UE 115-a, may operate based on accumulated energy through an energy harvester 225. If accumulated energy is not sufficient to perform communications, then the UE 115-a may continue to accumulate energy over time. Until enough energy is accumulated by the UE 115-a for performing wireless communication, the UE 115-a may not be reachable by the network (e.g., by the wireless device such as a sidelink UE 115 operating in mode 1, or a network entity 105). Because energy harvesting availability and rate may be unpredictable, communication quality between an energy harvesting device such as the UE 115-a and the network may also be unpredictable or intermittent. Techniques described herein may support a wireless protocol that can support reliable communications between the UE 115-a and the network. Harvesting methods may include photovoltaic, piezoelectric, electrostatic, electromagnetic, thermoelectric, pyroelectric, or antenna, harvesting techniques. The UE 115-a may be capable of performing energy harvesting by receiving signaling form the network entity 105-a.

The UE 115-a may include circuitry 210, and one or more antennas 270 for wireless communications and energy harvesting. The circuitry 210 may include a low-power RF transceiver 240, which may be in communication with a low-power microcontroller 235 (e.g., to process data received or for transmission via the transceiver). The low-power microcontroller may process data received from application 230 (e.g., for transmission), and may be in communication with power manager 220. The circuitry 210 may further include an RF energy harvester 225.

The energy harvester 225 may receive (e.g., via the antenna 270) RF input 245 at impedance matching circuitry 250. The voltage multiplier 255 may multiply voltage of the RF input 245, and the capacitor 260 may output harvested energy in the form of the DC output 265. The DC output 265 may be provided to the power manager 220, which may determine whether to store electricity obtained from the RF energy harvester 225 in the energy storage 215 (e.g., energy storing and/or rechargeable battery), or to use it for information transmission immediately (e.g., via the low-power microcontroller 235 and the low-=power RF transceiver 240).

As described here, the UE 115-a may perform energy harvesting using circuitry 210 by receiving energy transfer signals (e.g., defined beams transmitted by the network entity 105-a for energy harvesting) on energy transfer resources. The UE 115-a may perform energy harvesting on resources defined to be used by multiple UEs 115. Such resources may be indicated via an initial access procedure, or other control signaling. The UE 115-a may leverage and tune energy harvesting circuitry 210 to a certain band, bandwidth part, or set of resources (e.g., energy transfer resources) to accumulate RF/wireless energy via energy harvesting procedures. As described herein, the UE 115-a may determine the energy transfer resources based on a one-to-one, or a one-to-many mapping between SSB indices and the common resources. For example, the UE 115-a may receive one or more SSBs 275 from the network entity 105-a, and may determine one or more energy transfer resources on which to receive energy transfer signals 280 based on a mapping between SSB indices and the common energy transfer resources. In some examples, the mapping may also indicate a beam on which to receive the energy transfer signals (e.g., the same beam on which the preferred SSB 275 was received, or a different beam oriented toward another transmitter).

SSBs 275 may be received as part of or prior to random access procedures. For example, in a two-step random access procedure, the UE 115-a may receive control signaling such as SSBs 275, SIB, reference signals, RRC signaling (e.g., transmitted by the network entity 105-a to a connected UE 115-a). The UE 115-a may perform downlink synchronization, system information decoding and measurements. The UE 115-a may transmit a msg A preamble and a random access message A (msgA) payload (e.g., on a PRACH and PUSCH channel). The PUSCH may carry an RRC request, buffer status report (BSR), or small data. The network entity 105-a may then transmit a random access message B (msgB) on a PDCCH and PDSCH. The UE 115-a may then transmit msg B HARQ-ACK signaling on a PUCCH indicating hat it has received the msg B successfully. Two-step random access procedures may be used to transition from RRC idle/inactive state to RRC connected state, for small data transmissions in RRC idle or RR inactive state, for handover form a source to a target cell in n RRC connected state, or for RRC connected modes in which the UE 115-a recovers uplink synchronization loss.

SSBs 275 may be received as part of or prior to four-step random access procedures. In such examples, the UE 115-a may receive, from the network entity 105-a, one or more SSBs 275, and one or more SIB1s. The UE 115-a may transmit a random access message 1 (e.g., on a PRACH), and may receive a random access message 2 on a PCCH and PDSCH (e.g., a random access response (RAR)) including timing advance, information, an uplink grant for a random access message 3 (msg3) TC-RNTI). The UE 115-a may transmit a msg3 on the PUSCH, including an RRC connection request, SR, and buffer status. The UE 115-a may then receive a random access message 4 (msg4) on a PDCCH and PDSCH, including a contention resolution message.

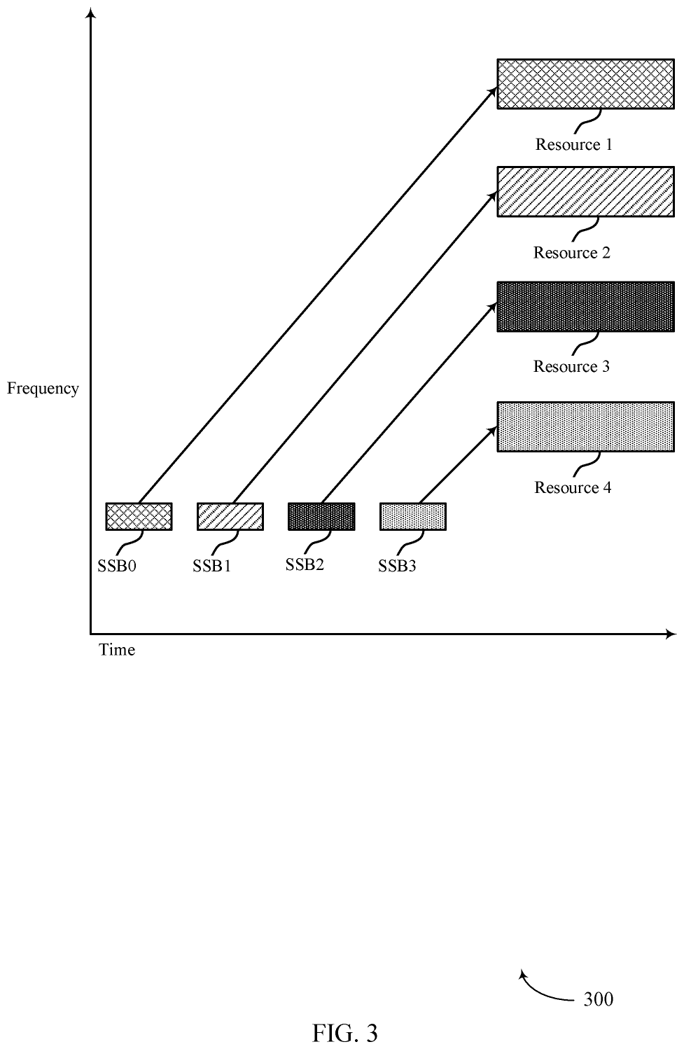

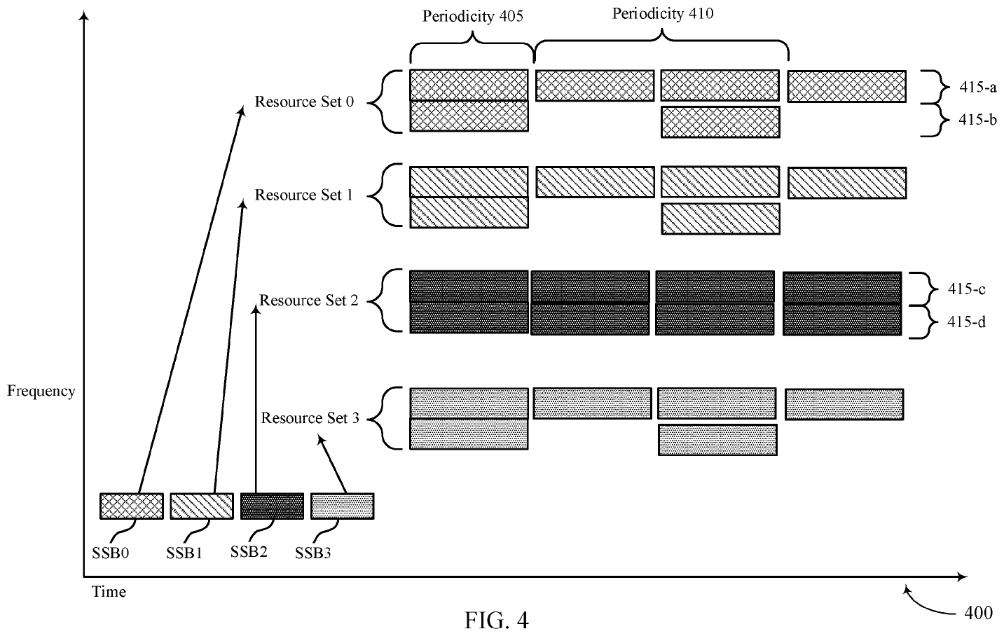

In two-step or four-step random access messages, the UE 115-a may rely on SSBs 275 to determine random access occasions on which to transmit random access messages. Similarly, the UE 115-a may receive SSBs 275, perform measurements, and determine a best or preferred SSB index (e.g., a beam on which SSBs were received with a highest quality, highest signal to noise ratio (SNR), or lowest interference). The UE 115-a may then determine resources on which to receive energy transfer signals 280, based on a mapping between the SSB index of the best SSB, and one or more energy transfer resources. Based on the SSB beam index, the UE 115-a may determine a one-to-one mapping (e.g., as described in greater detail with reference to FIG. 3) or one-to-many resources mapping (e.g., as described in greater detail with reference to FIG. 4) between the SSB beam index and one or more energy transfer resources. The network entity 105-a may beamform the energy transfer signal on the mapped resources using the same beam as the best SSB, and the UE 115-a may be expected to use the same spatial filter used to receive the best SSB 275 for receiving the energy transfer signal 280. In some examples, the network entity 105-a may beamform the energy transfer signal on the mapped resources using a different power source (e.g., the network entity 105-b). The network entity 105-b may provide one or more energy transfer signals 280 on the mapped energy transfer resources. The UE 115-a may be preconfigured or configured (e.g., according to the mapping, or as indicated in MIB (e.g., a physical broadcast channel in SIB1) to use a particular spatial filter to receive the energy transfer signal 280 (e.g., from the network entity 105-b). In some examples, the configuration of common energy transfer resources, the mapping between SSBs 275 and the energy transfer resources the beam (e.g., spatial filter) to use for the UE 115-a, or any combination thereof, may be configured via MIB, SIB1, or both.

The UE may receive an indication (e.g., via MIB, SIB, msg2, msg4, msgB, or OSIB, among other examples) of a set of known or common resources used for charging over the air a group of UEs 115, or specific resources used for charging just the UE 115-a (e.g., UE-specific resources).

In some examples, the UE 115-a may identify one or more energy harvesting bands, BWPs, subbands, sets of time-frequency resources, that are for energy harvesting (e.g., included in the defined set of energy transfer resources). Such resources may be configured or preconfigured at the UE 115-a, or defined in one or more standards documents. Such resources may be initially configured, and/or reconfigured/updated over time via random access signaling, SSB signaling, MAC-CE, or RRC signaling. The UE 115-a may adjust its energy harvesting circuitry 210 into one or more of the resources (e.g., bands, BWPs) based on an indication received form the network entity 105-a, or based on a best SSB beam, or a combination thereof. The UE 115-a may assume a certain preconfigured periodicity of such resources, or may be configured with periodicity via MIB, SIB1, msg2, msg4, msgB, or OSIB, among other examples,

The UE 115-a may begin receiving the energy transfer signals 280 using the mapped energy transfer resources, and the network entity 105-a may subsequently allocate UE-specific energy transfer resources (e.g., with better, narrower, beams) for the UE 115-a to monitor for energy transfer signals 280. For example, based on CSI-RS signaling and CSI reporting, the network entity 105-a may determine improved beams, and may allocate updated energy transfer resources on which the UE 115-a may receive energy transfer signals using better beams (e.g., based on the CSI reporting). In some examples, the updated resources may be for receiving energy transfer signals from another entity (e.g., a power cell, or the network entity 105-b). Such a power cell may be dedicated to providing power, and may be referred to as an RF emitter or RF source. In some examples, the power cell may be a customer premise equipment (CPE), UE 115, or small cell, and the configured resources (e.g., for CSI-RS signaling) may be between the power cell and the UE 115-a. New and updated resources may be indicated via layer 1 (L1), layer 2 (L2), and/or layer 3 (L3) signaling, and may be indicated during a connected mode.

Energy transfer signals may be a set of reference signals (e.g., on reference signal resources) that are quasi co-located with corresponding SSBs (e.g., certain SSB indices). In such examples, the network entity 105-a may set a report flag for the CSI-RSs set to none (e.g., reportQuantity=none) so that the UE 115-a is not instructed to send CSI reporting for the energy transfer signals (e.g., unless some charging rate reporting is needed, in which case the UE 115-a may receive the energy transfer signals in the form of CSI-RSs, and may transmit a report indicating a charging rate, or other charging related information).

In some examples, the network entity 105-a, or another network entity 105, may transmit data signals using time-frequency resources that at least partially overlap with the energy transfer resources. In such examples, the network entity 105-a may provide (e.g., via MIB, SIB1, msg2, msg4, msgB, or OSIB), an indication of one or more energy signal parameters (e.g., waveform, seed, identifier used to generate the energy signal sequence, a type of multiplexing within the set of configured resources for energy transfer, an energy signal DMRS configuration, among other examples). In such examples, the UE 115-a may use the indicated parameters to cancel out the energy signal, and successfully receive the data signaling.

In some examples, the network entity 105-a may indicate MBS, PRS, SSB 275, and/or other groupcasts or broadcast signals from nearby cells, transmit receive points (TRPs), or other network entities 105 (e.g., the network entity 105-b) to the UE 115-a, so that the UE 115-a can leverage such signaling to harvest RF energy. In some examples, the network entity 105-a may coordinate between nodes and across radio access technologies (RATs) (e.g., LTE, WLAN, WWAN, 5G NR, among other examples) so that the UE 115-a is able to configure energy harvesting circuitry 210 to harvest energy from transmissions of various different RATs.

FIG. 3 illustrates an example of an energy transfer resource scheme 300 that supports common energy signal configurations in accordance with one or more aspects of the present disclosure. Energy transfer resource scheme 300 may implement aspects of, or be implemented by aspects of, wireless communications system 100 and wireless communications system 200. For example, a UE and one or more network entities (e.g., a UE 115 and a network entity 105), which may be examples of corresponding devices described with reference to FIG. 1 and FIG. 2, may implement aspects of energy transfer resource scheme 300.

As described with reference to FIG. 2, the UE may receive one or more SSBs, and may select a best or preferred SSB. Each SSB may be mapped to an energy transfer resource (e.g., in a one-to-one mapping). If the UE determines that SSB0 is the best SSB, then the UE may monitor for energy transfer signals using resource 1. The UE may determine (e.g., according to the mapping, or control signaling, or as preconfigured at the UE) to use the same spatial filter that the UE used to receive the best SSB0. In some examples, the UE 115-a may use a different spatial filter (e.g., to receive the energy transfer signal from a different network entity, or using a different beam).

FIG. 4 illustrates an example of an energy transfer resource scheme 400 that supports common energy signal configurations in accordance with one or more aspects of the present disclosure. Energy transfer resource scheme 400 may implement aspects of, or be implemented by aspects of, wireless communications system 100 and wireless communications system 200. For example, a UE and one or more network entities (e.g., a UE 115 and a network entity 105), which may be examples of corresponding devices described with reference to FIG. 1 and FIG. 2, may implement aspects of energy transfer resource scheme 400.

As described with reference to FIG. 2, the UE may receive one or more SSBs, and may select a best or preferred SSB. Each SSB may be mapped to an energy transfer resource (e.g., in a one-to-one mapping). If the UE determines that SSB0 is the best SSB, then the UE may monitor for energy transfer signals using resource set 0. The UE may determine (e.g., according to the mapping, or control signaling, or as preconfigured at the UE) to use the same spatial filter that the UE used to receive the best SSB0. In some examples, the UE 115-a may use a different spatial filter (e.g., to receive the energy transfer signal from a different network entity, or using a different beam).

In a one-to-many resource mapping, each subset 415 of a resource set may be associated with a charging rate. For example, the network entity may transmit energy transfer signals at different power levels in the subset 415-c and in the subset 415-d of resource set 2 In some examples, the subset 415-a of the resource set 0 may have more resources than the subset 415-b of the resource set 0, or the resources may have different sizes (e.g., resulting in different charging rates). Different subsets 415 of resource sets may be associated with different periodicities, where a larger or increased periodicity may support a higher charging rate. Different subsets 415 of resource sets may be associated with different energy harvesting technology (e.g., solar energy harvesting, thermal energy harvesting, RF thermal harvesting). In some examples, different subsets 415 of resource sets may be associated with different frequency resources (e.g., different frequency bands, different BWPs, different ranges). For instance, the subset 415-c of resource set 2 may be associated with a first band, and the subset 415-d of resource set 2 may be associated with second band. The UE may map SSB2 to the resource set 2, and may select the subset 415 associated with the frequency band at which the UE has the best efficiency for energy harvesting.

Upon mapping an SSB to a resource set, the UE may select the subset 415 that is associated with the UE type, harvesting type, most efficient frequency range, or other parameters. For example, if the UE maps SSB0 to the resource set 0, and supports a high charging rate, then the UE may select subset 415-a because subset 415-a has a higher charging rate due to the smaller periodicity 405. If the UE supports a lower charging rate, then the UE may select subset 415-b because subset 415-b has a lower charging rate due to the larger periodicity 410.

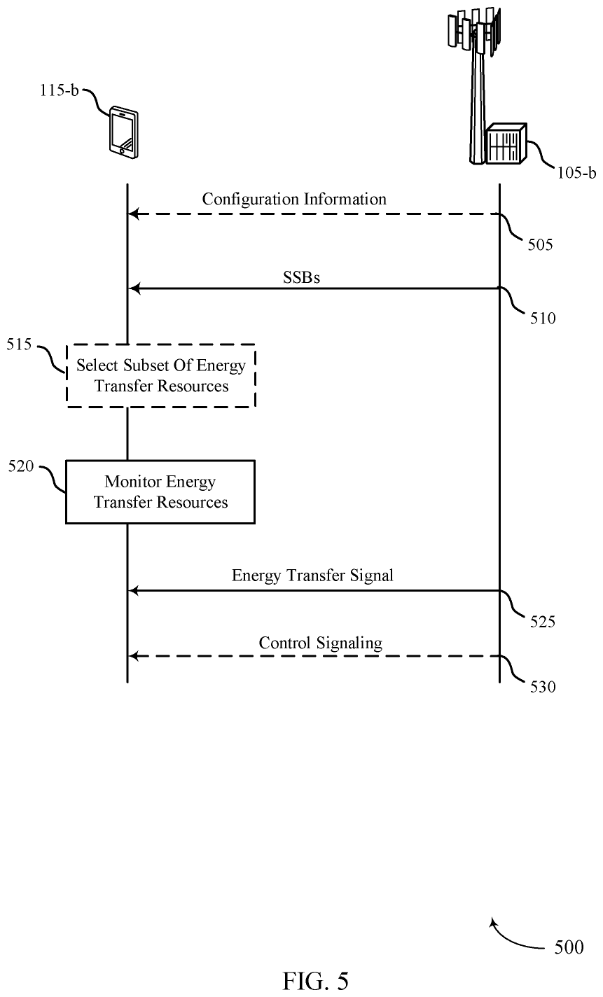

FIG. 5 illustrates an example of a process flow 500 that supports common energy signal configurations in accordance with one or more aspects of the present disclosure. Process flow 500 may include a UE 115-b, and a network entity 105-b, which may be examples of corresponding devices described with reference to FIGS. 1-4. The process flow 500 may implement aspects of, or be implemented by aspects of, wireless communications system 100, wireless communications system 200, an energy transfer resource scheme 300, or energy transfer resource scheme 400.

At 505, the network entity 105-b may transmit, and the UE 115-b may receive, configuration information. The configuration information may include a mapping between one or more SSB indices and one or more energy transfer resources. The configuration information may be included in system information (SIB1, SIB2, OSIB), master information (MIB), a random access message (msg2, msg4, msgB), or any combination thereof. The configuration information may include an indication of a one-to-one mapping between SSB indices and respective energy transfer resources (e.g., as described with reference to FIG. 3) or a one-to-many mapping as described with reference to FIG. 4). At 510, the UE 115-b may receive (e.g., from the network entity 105-b or another network entity, or a combination thereof) the one or more SSBs. The UE 115-b may perform one or more measurements to determine a best or preferred SSB. The SSB may correspond to a beam on which to communicate with the network entity 105-b.

At 515, the UE 115-b may monitor the energy transfer resources for energy transfer signals. The energy transfer resources may correspond to a selected SSB index, according to the mapping. The UE 115-b may monitor for the energy transfer signals on the energy transfer resources using a beam associated with the mapping (e.g., the same beam on which the UE 115-b received the best SSB, or a different beam associated with the energy transfer resources according to the mapping).

In some examples, at 515, the UE 115-b may select a subset of energy transfer resources on which to monitor for the energy transfer resources at 520. For example, the mapping may be a one-to-many mapping, as described in greater detail with reference to FIG. 4. Each subset of multiple subsets of energy transfer resources may be associated with a respective energy transfer type (e.g., solar, RF, thermal energy harvesting). In some examples, each subset of the subsets of energy transfer resources may be associated with a respective energy transfer charging rate, type of energy harvesting, a respective set of frequency resources (e.g., BWP, frequency band), a respective periodicity, a respective UE power setting, or any combination thereof. The UE 115-b may determine its own type or other parameters (e.g., a most effective frequency range for energy harvesting circuitry, a current power setting, a supported or preferred charging rate, a current battery power setting or charge level, an energy transfer type, or any combination thereof, and may then select a subset of energy transfer resources based on the type or parameter.

At 525, the UE 115-b may receive the energy transfer signals using the energy transfer resources, based at least in part on the monitoring. The energy transfer signals may be reference signals (e.g., CSI-RSs) that are quasi co-located with the transmission beam on which the UE 115-b received the best SSB (e.g., or a different beam per the mapping). The UE 115-b may receive (e.g., at 505 or in separate signaling) an instruction that the UE 115-b refrain from transmitting a measurement report associated with the reference signals. The UE 115-b may perform energy harvesting on the received energy transfer signals according to energy harvesting circuitry (e.g., as described with reference to FIG. 2).

In some examples, UE may tune energy harvesting circuitry to a set of frequency resources of the set of energy transfer resources mapped to the SSBs (e.g., or selected at 515). In some examples, at 530, the UE 115-b may receive (e.g., from the network entity 105-b) control signaling indicting a second set of frequency resources for a second set of energy transfer resources. In such examples, the UE 115-b may retune its energy harvesting circuitry to the second set of energy transfer resources. In some examples, the control signaling may indicate a second set of resources based on CSI-RS transmissions, or CSI-RS reporting. The second set of energy transfer resources may be associated with a set of (e.g., narrow) transmission beams which may be more refined than beams previously used for receiving the energy transfer signal. The UE 115-b may monitor the second set of energy transfer resources using the set of narrower beams, and may perform energy harvesting based on receiving energy transfer signals thereon.

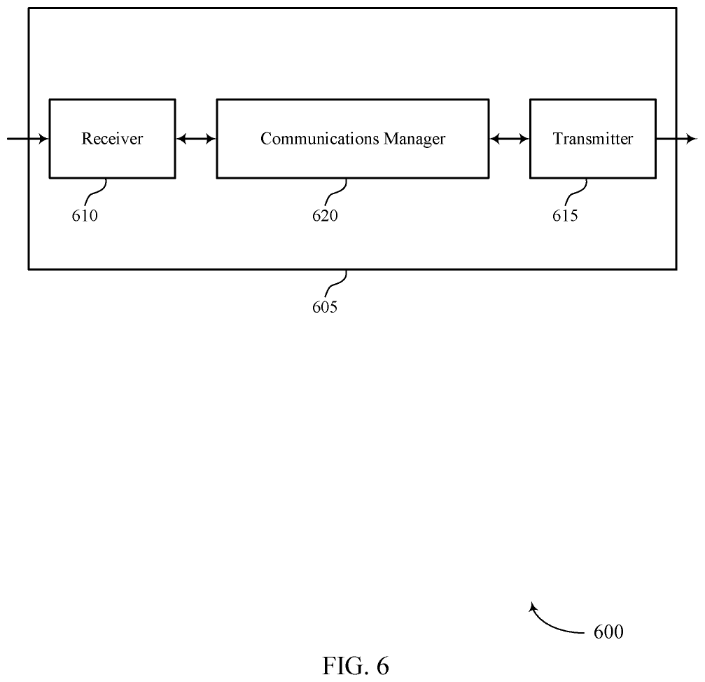

FIG. 6 shows a block diagram 600 of a device 605 that supports common energy signal configurations in accordance with one or more aspects of the present disclosure. The device 605 may be an example of aspects of a UE 115 as described herein. The device 605 may include a receiver 610, a transmitter 615, and a communications manager 620. In some examples, the communications manager 620, may include or may manager one or more aspects of circuitry 210. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to common energy signal configurations). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to common energy signal configurations). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of common energy signal configurations as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software) executed by a processor. If implemented in code executed by a processor, the functions of the communications manager 620, the receiver 610, the transmitter 615, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. For example, the communications manager 620 may be configured as or otherwise support a means for receiving a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The communications manager 620 may be configured as or otherwise support a means for monitoring a set of one or more energy transfer resources for one or more energy transfer signals, the set of one or more energy transfer resources corresponding to a first SSB of the set of multiple SSBs according to the mapping. The communications manager 620 may be configured as or otherwise support a means for performing energy harvesting using the one or more energy transfer signals.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for energy transfer procedures resulting in more efficient energy harvesting, improved battery life, efficient utilization of available energy, efficient use of system resources, and improved user experience.

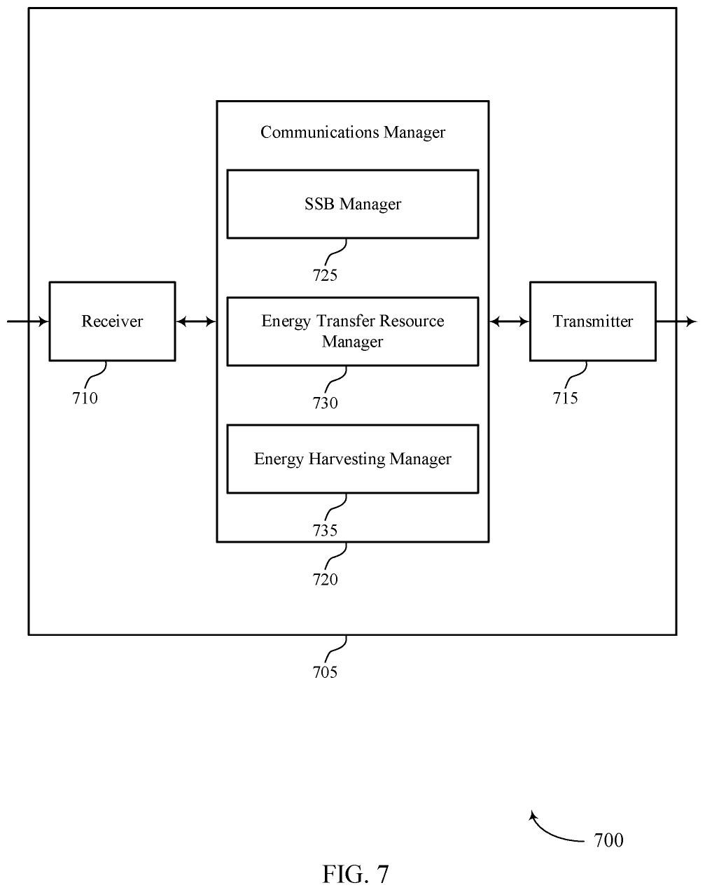

FIG. 7 shows a block diagram 700 of a device 705 that supports common energy signal configurations in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to common energy signal configurations). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to common energy signal configurations). In some examples, the transmitter 715 may be co-located with a receiver 710 in a transceiver module (e.g., a low-power RF transceiver 240). The transmitter 715 may utilize a single antenna or a set of multiple antennas.

The device 705, or various components thereof, may be an example of means for performing various aspects of common energy signal configurations as described herein. For example, the communications manager 720 may include an SSB manager 725, an energy transfer resource manager 730, an energy harvesting manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. The SSB manager 725 may be configured as or otherwise support a means for receiving a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The energy transfer resource manager 730 may be configured as or otherwise support a means for monitoring a set of one or more energy transfer resources for one or more energy transfer signals, the set of one or more energy transfer resources corresponding to a first SSB of the set of multiple SSBs according to the mapping. The energy harvesting manager 735 may be configured as or otherwise support a means for performing energy harvesting using the one or more energy transfer signals. The energy harvesting manager 735 may include, or may manage, aspects of energy harvester 225.

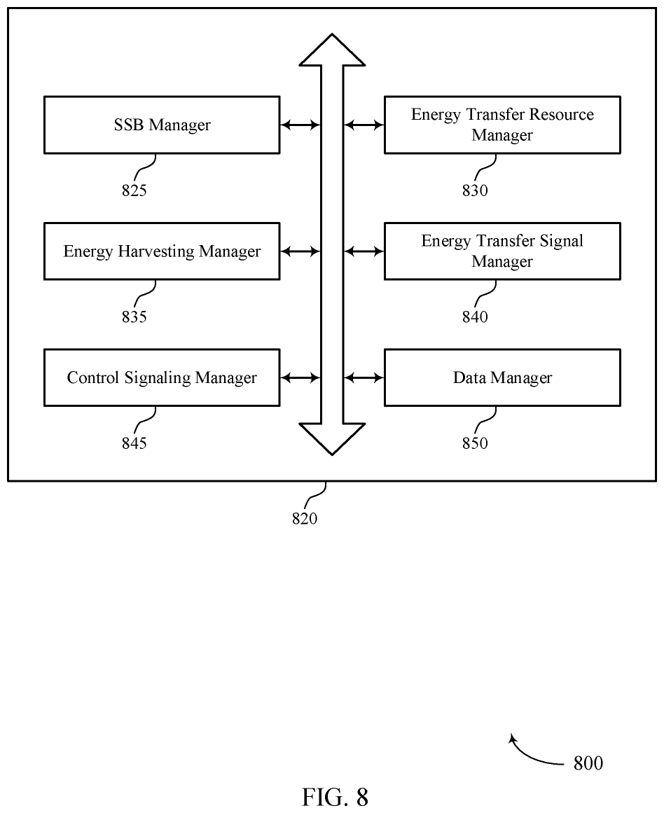

FIG. 8 shows a block diagram 800 of a communications manager 820 that supports common energy signal configurations in accordance with one or more aspects of the present disclosure. The communications manager 820 may be an example of aspects of a communications manager 620, a communications manager 720, or both, as described herein. The communications manager 820, or various components thereof, may be an example of means for performing various aspects of common energy signal configurations as described herein. For example, the communications manager 820 may include an SSB manager 825, an energy transfer resource manager 830, an energy harvesting manager 835, an energy transfer signal manager 840, a control signaling manager 845, a data manager 850, or any combination thereof. Each of these components may communicate, directly or indirectly, with one another (e.g., via one or more buses).

The communications manager 820 may support wireless communications at a UE in accordance with examples as disclosed herein. The SSB manager 825 may be configured as or otherwise support a means for receiving a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The energy transfer resource manager 830 may be configured as or otherwise support a means for monitoring a set of one or more energy transfer resources for one or more energy transfer signals, the set of one or more energy transfer resources corresponding to a first SSB of the set of multiple SSBs according to the mapping. The energy harvesting manager 835 may be configured as or otherwise support a means for performing energy harvesting using the one or more energy transfer signals. The energy transfer signal manager 835 may include, or may manage, aspects of energy harvester 225, lower-power RF transceiver 240, power manager 220, or other aspects of circuitry 210.

In some examples, the energy transfer signal manager 840 may be configured as or otherwise support a means for receiving, based on the monitoring, the one or more energy transfer signals using a spatial filter that is associated with the set of one or more energy transfer resources according to a further mapping between the spatial filter and the set of one or more energy transfer resources, where the spatial filter is not associated with a first transmission beam corresponding to the first SSB. The energy transfer signal manager 840 may include, or may manage, aspects of energy harvester 225, lower-power RF transceiver 240, or other aspects of circuitry 210.

In some examples, the energy transfer signal manager 840 may be configured as or otherwise support a means for receiving, based on the monitoring, the one or more energy transfer signals using a spatial filter that is associated with a first transmission beam corresponding to the first SSB according to a further mapping between the first transmission beam corresponding to the first SSB and the set of one or more energy transfer resources.

In some examples, the energy transfer signal manager 840 may be configured as or otherwise support a means for receiving an indication that the UE refrain from transmitting a measurement report associated with the one or more energy transfer signals, where the one or more energy transfer signals include reference signals that are quasi co-located with a transmission beam of the set of multiple respective transmission beams that is associated with the first SSB.

In some examples, the energy transfer resource manager 830 may be configured as or otherwise support a means for selecting a first subset of the set of one or more energy transfer resources based on an energy transfer type of the UE, where each subset of a set of multiple subsets of the set of one or more energy transfer resources is associated with a respective energy transfer type of a set of multiple energy transfer types.

In some examples, each subset of the set of multiple subsets of the set of one or more energy transfer resources is associated with a respective energy transfer charging rate.

In some examples, each subset of the set of multiple subsets of the set of one or more energy transfer resources is associated with a respective type of energy harvesting, a respective set of frequency resources, a respective periodicity, a respective UE power setting, or any combination thereof.

In some examples, the control signaling manager 845 may be configured as or otherwise support a means for receiving system information, master information, or a random access message, including an indication of the mapping.

In some examples, the control signaling manager 845 may be configured as or otherwise support a means for receiving control signaling indicating a second set of frequency resource associated with a second set of one or more energy transfer resources.

In some examples, the energy harvesting manager 835 may be configured as or otherwise support a means for tuning energy harvesting circuitry at the UE to the first set of frequency resources associated with the set of one or more energy transfer resources, where performing the energy harvesting is based on the tuning. In some examples, the energy harvesting manager 835 may be configured as or otherwise support a means for retuning to the second set of one or more energy transfer resources according to the control signaling.

In some examples, the energy transfer resource manager 830 may be configured as or otherwise support a means for receiving an indication of a second set of one or more energy transfer resources, where the set of one or more energy transfer resources is associated with a first set of transmission beams and the second set of one or more energy transfer resources are associated with a second set of transmission beams, and where the second set of transmission beams are more narrow than the first set of transmission beams. In some examples, the energy transfer signal manager 840 may be configured as or otherwise support a means for monitoring for one or more additional energy transfer signals using the second set of one or more energy transfer resources over the second set of transmission beams. In some examples, the energy harvesting manager 835 may be configured as or otherwise support a means for performing energy harvesting using the one or more additional energy transfer signals.

In some examples, the data manager 850 may be configured as or otherwise support a means for receiving an indication of one or more parameters associated with the one or more energy transfer signals. In some examples, the data manager 850 may be configured as or otherwise support a means for monitoring for data transmissions during at least a portion of the set of one or more energy transfer resources. In some examples, the data manager 850 may be configured as or otherwise support a means for canceling the one or more energy transfer signals based on the one or more parameters. In some examples, the data manager 850 may be configured as or otherwise support a means for decoding the data transmissions based on the canceling.

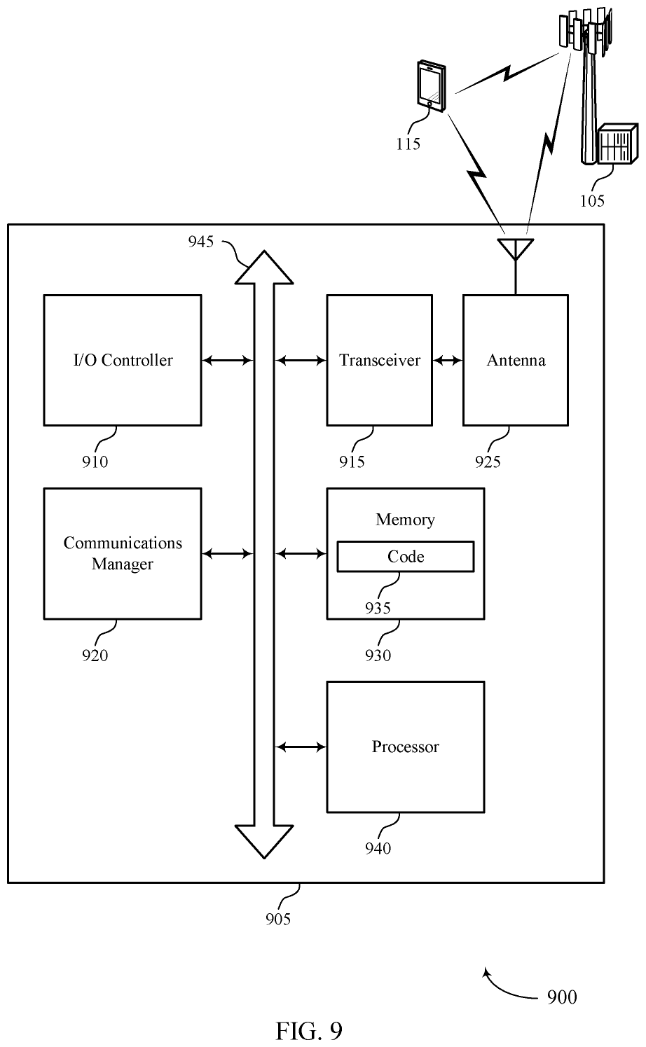

FIG. 9 shows a diagram of a system 900 including a device 905 that supports common energy signal configurations in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915 (e.g., a low-power RF transceiver 240), an antenna 925 (e.g., an antenna 270), a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting common energy signal configurations). For example, the device 905 or a component of the device 905 may include a processor 940 and memory 930 coupled with or to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The communications manager 920 may be configured as or otherwise support a means for monitoring a set of one or more energy transfer resources for one or more energy transfer signals, the set of one or more energy transfer resources corresponding to a first SSB of the set of multiple SSBs according to the mapping. The communications manager 920 may be configured as or otherwise support a means for performing energy harvesting using the one or more energy transfer signals. The communications manager 920 may include, or may manage, aspects of energy harvester 225, lower-power RF transceiver 240, power manager 220, or other aspects of circuitry 210.

By including or configuring the communications manager 920 in accordance with examples as described herein, the device 905 may support techniques for energy transfer procedures resulting in more efficient energy harvesting, improved battery life, efficient utilization of available energy, efficient use of system resources, and improved user experience.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of common energy signal configurations as described herein, or the processor 940 and the memory 930 may be otherwise configured to perform or support such operations.

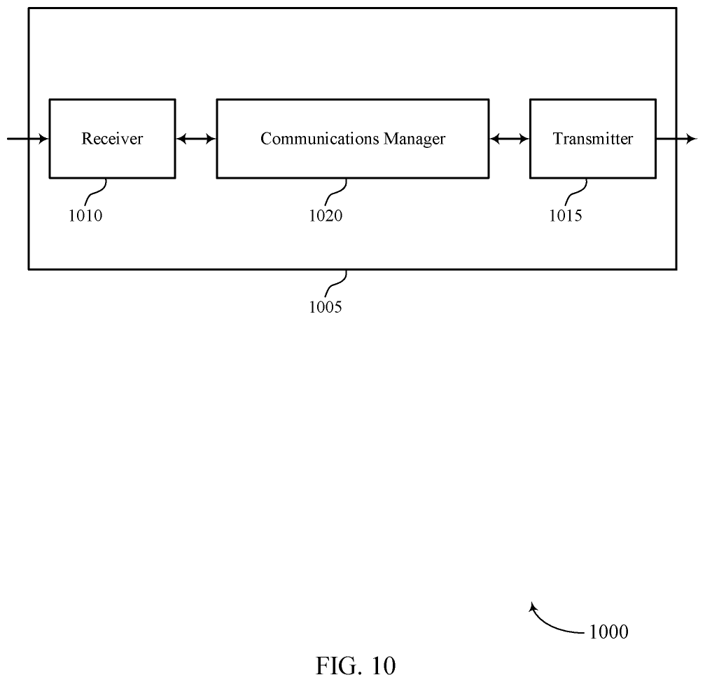

FIG. 10 shows a block diagram 1000 of a device 1005 that supports common energy signal configurations in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of common energy signal configurations as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software) executed by a processor. If implemented in code executed by a processor, the functions of the communications manager 1020, the receiver 1010, the transmitter 1015, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. For example, the communications manager 1020 may be configured as or otherwise support a means for outputting a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The communications manager 1020 may be configured as or otherwise support a means for outputting one or more energy transfer signals on a set of one or more energy transfer resources, the set of one or more energy transfer resources corresponding to a first SSB of the set of multiple SSBs according to the mapping.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for energy transfer procedures resulting in more efficient energy harvesting, improved battery life, efficient utilization of available energy, efficient use of system resources, and improved user experience.

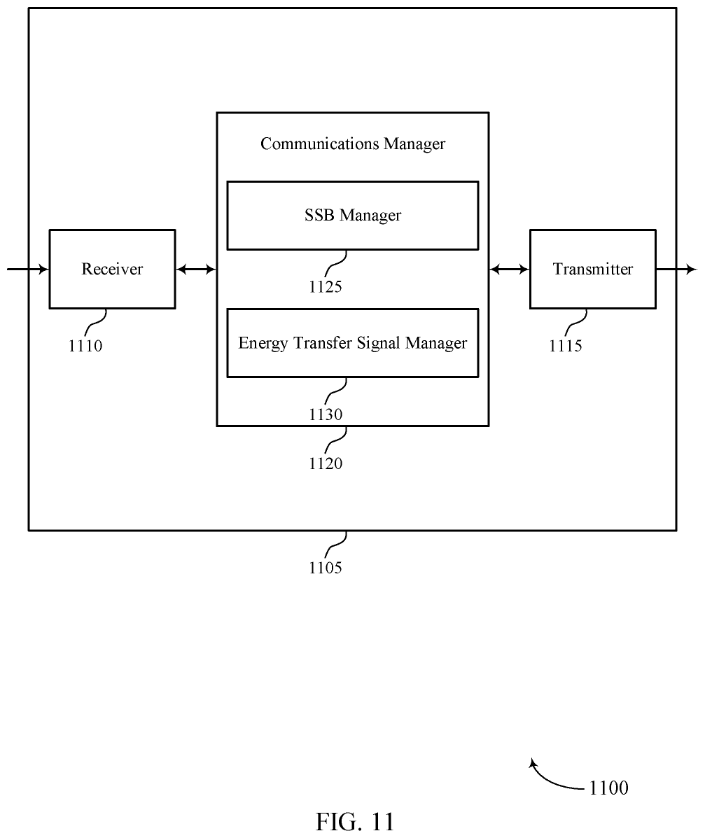

FIG. 11 shows a block diagram 1100 of a device 1105 that supports common energy signal configurations in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of common energy signal configurations as described herein. For example, the communications manager 1120 may include an SSB manager 1125 an energy transfer signal manager 1130, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. The SSB manager 1125 may be configured as or otherwise support a means for outputting a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The energy transfer signal manager 1130 may be configured as or otherwise support a means for outputting one or more energy transfer signals on a set of one or more energy transfer resources, the set of one or more energy transfer resources corresponding to a first SSB of the set of multiple SSBs according to the mapping.

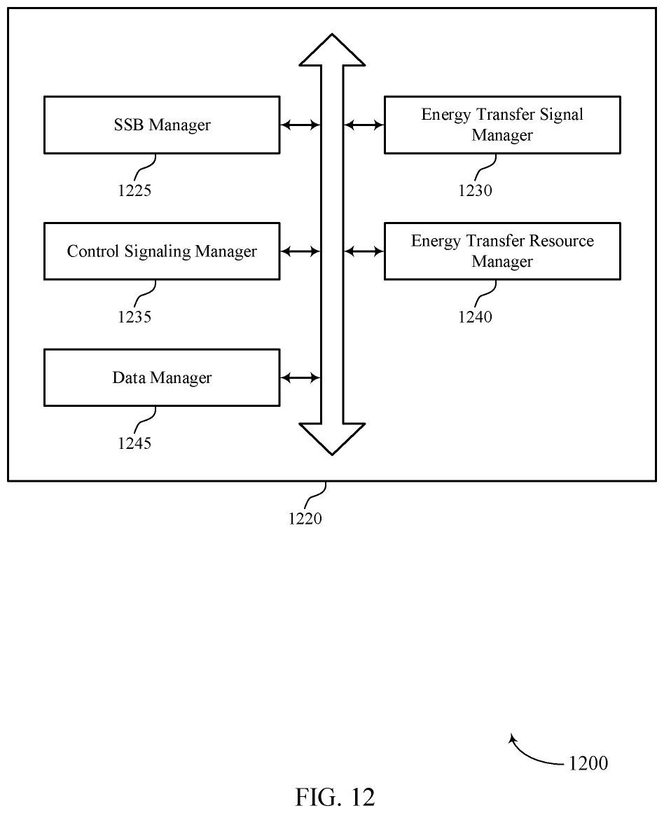

FIG. 12 shows a block diagram 1200 of a communications manager 1220 that supports common energy signal configurations in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of common energy signal configurations as described herein. For example, the communications manager 1220 may include an SSB manager 1225, an energy transfer signal manager 1230, a control signaling manager 1235, an energy transfer resource manager 1240, a data manager 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The SSB manager 1225 may be configured as or otherwise support a means for outputting a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The energy transfer signal manager 1230 may be configured as or otherwise support a means for outputting one or more energy transfer signals on a set of one or more energy transfer resources, the set of one or more energy transfer resources corresponding to a first SSB of the set of multiple SSBs according to the mapping.

In some examples, the energy transfer signal manager 1230 may be configured as or otherwise support a means for outputting the one or more energy transfer signals using a transmission beam that is associated with the set of one or more energy transfer resources according to a further mapping between the transmission beam and the set of one or more energy transfer resources, where the transmission beam is not associated with a first transmission beam of the set of multiple transmission beams corresponding to the first SSB.

In some examples, the energy transfer signal manager 1230 may be configured as or otherwise support a means for outputting the one or more energy transfer signals using a first transmission beam of the set of multiple transmission beams that is associated with the set of one or more energy transfer resources according to a further mapping between the first transmission beam and the set of one or more energy transfer resources, where the first SSB is output using the first transmission beam.

In some examples, the energy transfer signal manager 1230 may be configured as or otherwise support a means for outputting an indication that a UE refrain from transmitting a measurement report associated with the one or more energy transfer signals, where the one or more energy transfer signals include reference signals that are quasi co-located with a transmission beam of the set of multiple respective transmission beams that is associated with the first SSB.

In some examples, each subset of a set of multiple subsets of the set of one or more energy transfer resources is associated with a respective energy transfer type of a set of multiple energy transfer types.

In some examples, each subset of a set of multiple subsets of the set of one or more energy transfer resources is associated with a respective energy transfer charging rate.

In some examples, each subset of a set of multiple subsets of the set of one or more energy transfer resources is associated with a respective type of energy harvesting, a respective set of frequency resources, a respective periodicity, a respective UE power setting, or any combination thereof.

In some examples, the control signaling manager 1235 may be configured as or otherwise support a means for outputting system information, master information, or a random access message, including an indication of the mapping.

In some examples, the control signaling manager 1235 may be configured as or otherwise support a means for outputting control signaling indicating a second set of frequency resource associated with a second set of one or more energy transfer resources.

In some examples, the energy transfer resource manager 1240 may be configured as or otherwise support a means for outputting an indication of a second set of one or more energy transfer resources, where the set of one or more energy transfer resources is associated with a first set of transmission beams and the second set of one or more energy transfer resources are associated with a second set of transmission beams, and where the second set of transmission beams are more narrow than the first set of transmission beams. In some examples, the energy transfer signal manager 1230 may be configured as or otherwise support a means for outputting one or more additional energy transfer signals using the second set of one or more energy transfer resources over the second set of transmission beams.

In some examples, the data manager 1245 may be configured as or otherwise support a means for outputting an indication of one or more parameters associated with the one or more energy transfer signals. In some examples, the data manager 1245 may be configured as or otherwise support a means for outputting data signaling on at least a portion of the set of one or more energy transfer resources based on outputting the indication of the one or more parameters.

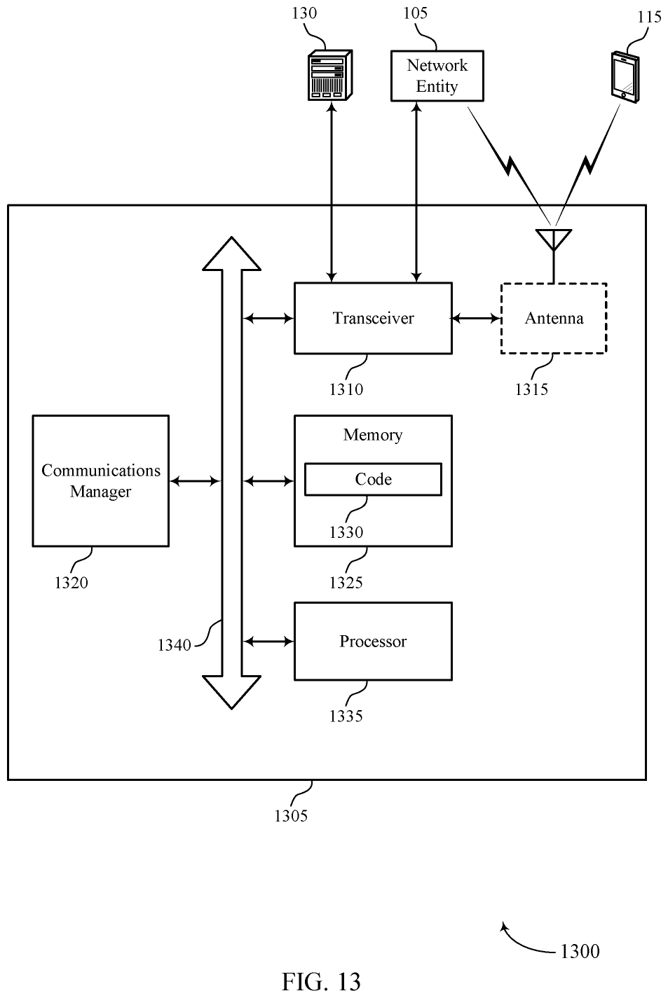

FIG. 13 shows a diagram of a system 1300 including a device 1305 that supports common energy signal configurations in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310 (e.g., a low-power RF transceiver 240), an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. The transceiver 1310, or the transceiver 1310 and one or more antennas 1315 or wired interfaces, where applicable, may be an example of a transmitter 1015, a transmitter 1115, a receiver 1010, a receiver 1110, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting common energy signal configurations). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity in accordance with examples as disclosed herein. For example, the communications manager 1320 may be configured as or otherwise support a means for outputting a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The communications manager 1320 may be configured as or otherwise support a means for outputting one or more energy transfer signals on a set of one or more energy transfer resources, the set of one or more energy transfer resources corresponding to a first SSB of the set of multiple SSBs according to the mapping.

By including or configuring the communications manager 1320 in accordance with examples as described herein, the device 1305 may support techniques for energy transfer procedures resulting in more efficient energy harvesting, improved battery life, efficient utilization of available energy, efficient use of system resources, and improved user experience.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the processor 1335, the memory 1325, the code 1330, the transceiver 1310, or any combination thereof. For example, the code 1330 may include instructions executable by the processor 1335 to cause the device 1305 to perform various aspects of common energy signal configurations as described herein, or the processor 1335 and the memory 1325 may be otherwise configured to perform or support such operations.

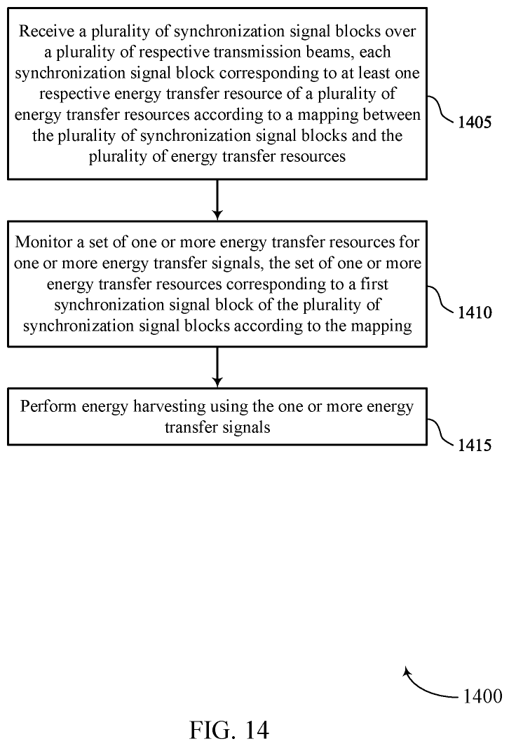

FIG. 14 shows a flowchart illustrating a method 1400 that supports common energy signal configurations in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The operations of 1405 may be performed in accordance with examples as disclosed herein. In some examples, aspects of the operations of 1405 may be performed by an SSB manager 825 as described with reference to FIG. 8.

At 1410, the method may include monitoring a set of one or more energy transfer resources for one or more energy transfer signals, the set of one or more energy transfer resources corresponding to a first SSB of the set of multiple SSBs according to the mapping. The operations of 1410 may be performed in accordance with examples as disclosed herein. In some examples, aspects of the operations of 1410 may be performed by an energy transfer resource manager 830 as described with reference to FIG. 8.

At 1415, the method may include performing energy harvesting using the one or more energy transfer signals. The operations of 1415 may be performed in accordance with examples as disclosed herein. In some examples, aspects of the operations of 1415 may be performed by an energy harvesting manager 835 as described with reference to FIG. 8.

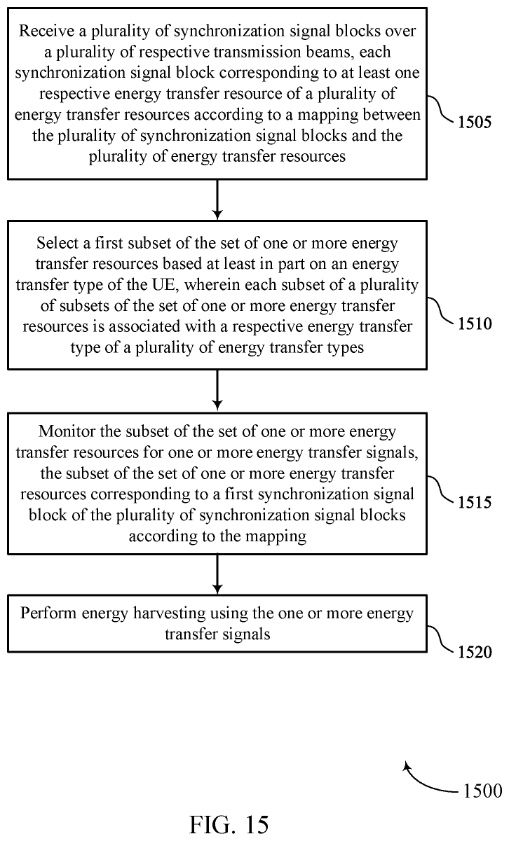

FIG. 15 shows a flowchart illustrating a method 1500 that supports common energy signal configurations in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The operations of 1505 may be performed in accordance with examples as disclosed herein. In some examples, aspects of the operations of 1505 may be performed by an SSB manager 825 as described with reference to FIG. 8.

At 1510, the method may include selecting a first subset of the set of one or more energy transfer resources based on an energy transfer type of the UE, where each subset of a set of multiple subsets of the set of one or more energy transfer resources is associated with a respective energy transfer type of a set of multiple energy transfer types. The operations of 1510 may be performed in accordance with examples as disclosed herein. In some examples, aspects of the operations of 1510 may be performed by an energy transfer resource manager 830 as described with reference to FIG. 8.

At 1515, the method may include monitoring the subset of the set of one or more energy transfer resources for one or more energy transfer signals, the subset of the set of one or more energy transfer resources corresponding to a first SSB of the plurality of SSBs according to the mapping. The operations of 1515 may be performed in accordance with examples as disclosed herein. In some examples, aspects of the operations of 1515 may be performed by an energy transfer resource manager 830 as described with reference to FIG. 8.

At 1520, the method may include performing energy harvesting using the one or more energy transfer signals. The operations of 1520 may be performed in accordance with examples as disclosed herein. In some examples, aspects of the operations of 1520 may be performed by an energy harvesting manager 835 as described with reference to FIG. 8.

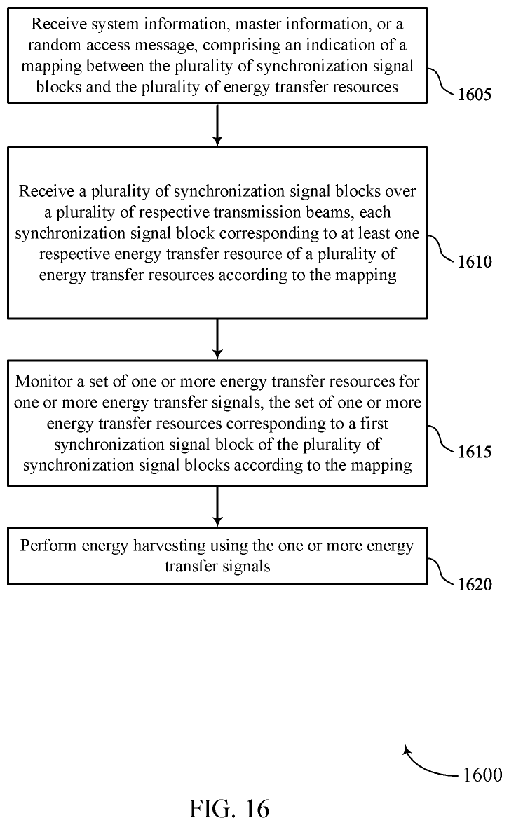

FIG. 16 shows a flowchart illustrating a method 1600 that supports common energy signal configurations in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving system information, master information, or a random access message, comprising an indication of a mapping between the plurality of SSBs and the plurality of energy transfer resources. The operations of 1605 may be performed in accordance with examples as disclosed herein. In some examples, aspects of the operations of 1605 may be performed by a control signaling manager 845 as described with reference to FIG. 8.

At 1610, the method may include receiving a plurality of SSBs over a plurality of respective transmission beams, each SSB corresponding to at least one respective energy transfer resource of a plurality of energy transfer resources according to the mapping. The operations of 1610 may be performed in accordance with examples as disclosed herein. In some examples, aspects of the operations of 1610 may be performed by an SSB manager 825 as described with reference to FIG. 8.

At 1615, the method may include monitoring a set of one or more energy transfer resources for one or more energy transfer signals, the set of one or more energy transfer resources corresponding to a first SSB of the set of multiple SSBs according to the mapping. The operations of 1615 may be performed in accordance with examples as disclosed herein. In some examples, aspects of the operations of 1615 may be performed by an energy transfer resource manager 830 as described with reference to FIG. 8.

At 1620, the method may include performing energy harvesting using the one or more energy transfer signals. The operations of 1620 may be performed in accordance with examples as disclosed herein. In some examples, aspects of the operations of 1620 may be performed by an energy harvesting manager 835 as described with reference to FIG. 8.

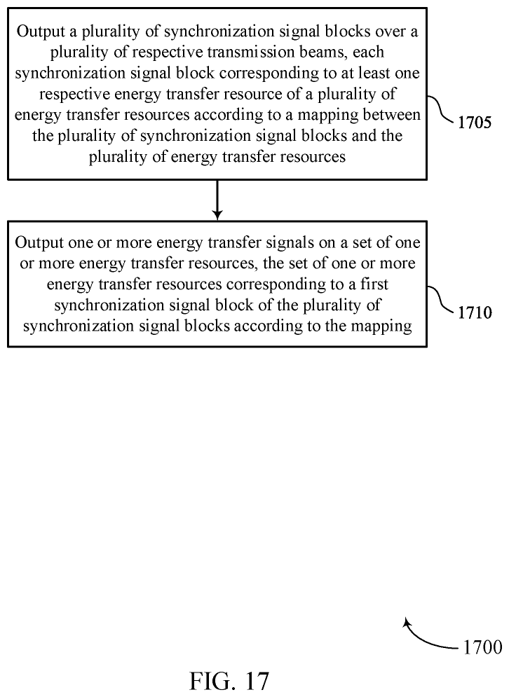

FIG. 17 shows a flowchart illustrating a method 1700 that supports common energy signal configurations in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include outputting a set of multiple SSBs over a set of multiple respective transmission beams, each SSB corresponding to at least one respective energy transfer resource of a set of multiple energy transfer resources according to a mapping between the set of multiple SSBs and the set of multiple energy transfer resources. The operations of 1705 may be performed in accordance with examples as disclosed herein. In some examples, aspects of the operations of 1705 may be performed by an SSB manager 1225 as described with reference to FIG. 12.

At 1710, the method may include outputting one or more energy transfer signals on a set of one or more energy transfer resources, the set of one or more energy transfer resources corresponding to a first SSB of the set of multiple SSBs according to the mapping. The operations of 1710 may be performed in accordance with examples as disclosed herein. In some examples, aspects of the operations of 1710 may be performed by an energy transfer signal manager 1230 as described with reference to FIG. 12.

The following provides an overview of aspects of the present disclosure:

Aspect 1: A method for wireless communications at a UE, comprising: receiving a plurality of SSBs over a plurality of respective transmission beams, each SSB corresponding to at least one respective energy transfer resource of a plurality of energy transfer resources according to a mapping between the plurality of SSBs and the plurality of energy transfer resources; monitoring a set of one or more energy transfer resources for one or more energy transfer signals, the set of one or more energy transfer resources corresponding to a first SSB of the plurality of SSBs according to the mapping; and performing energy harvesting using the one or more energy transfer signals.

Aspect 2: The method of aspect 1, further comprising: receiving, based at least in part on the monitoring, the one or more energy transfer signals using a spatial filter that is associated with the set of one or more energy transfer resources according to a further mapping between the spatial filter and the set of one or more energy transfer resources, wherein the spatial filter is not associated with a first transmission beam corresponding to the first SSB.

Aspect 3: The method of any of aspects 1 through 2, further comprising: receiving, based at least in part on the monitoring, the one or more energy transfer signals using a spatial filter that is associated with a first transmission beam corresponding to the first SSB according to a further mapping between the first transmission beam corresponding to the first SSB and the set of one or more energy transfer resources.

Aspect 4: The method of aspect 3, further comprising: receiving an indication that the UE refrain from transmitting a measurement report associated with the one or more energy transfer signals, wherein the one or more energy transfer signals comprise reference signals that are quasi co-located with a transmission beam of the plurality of respective transmission beams that is associated with the first SSB.

Aspect 5: The method of any of aspects 1 through 4, further comprising: selecting a first subset of the set of one or more energy transfer resources based at least in part on an energy transfer type of the UE, wherein each subset of a plurality of subsets of the set of one or more energy transfer resources is associated with a respective energy transfer type of a plurality of energy transfer types.

Aspect 6: The method of aspect 5, wherein each subset of the plurality of subsets of the set of one or more energy transfer resources is associated with a respective energy transfer charging rate.

Aspect 7: The method of any of aspects 5 through 6, wherein each subset of the plurality of subsets of the set of one or more energy transfer resources is associated with a respective type of energy harvesting, a respective set of frequency resources, a respective periodicity, a respective UE power setting, or any combination thereof.

Aspect 8: The method of any of aspects 1 through 7, further comprising: receiving system information, master information, or a random access message, comprising an indication of the mapping.

Aspect 9: The method of any of aspects 1 through 8, wherein the set of one or more energy transfer resources are associated with a first set of frequency resources, further comprising: receiving control signaling indicating a second set of frequency resource associated with a second set of one or more energy transfer resources.

Aspect 10: The method of aspect 9, further comprising: tuning energy harvesting circuitry at the UE to the first set of frequency resources associated with the set of one or more energy transfer resources, wherein performing the energy harvesting is based at least in part on the tuning; and retuning to the second set of one or more energy transfer resources according to the control signaling.

Aspect 11: The method of any of aspects 1 through 10, further comprising: receiving an indication of a second set of one or more energy transfer resources, wherein the set of one or more energy transfer resources is associated with a first set of transmission beams and the second set of one or more energy transfer resources are associated with a second set of transmission beams, and wherein the second set of transmission beams are more narrow than the first set of transmission beams; monitoring for one or more additional energy transfer signals using the second set of one or more energy transfer resources over the second set of transmission beams; and performing energy harvesting using the one or more additional energy transfer signals.

Aspect 12: The method of any of aspects 1 through 11, further comprising: receiving an indication of one or more parameters associated with the one or more energy transfer signals; monitoring for data transmissions during at least a portion of the set of one or more energy transfer resources; canceling the one or more energy transfer signals based at least in part on the one or more parameters; and decoding the data transmissions based at least in part on the canceling.

Aspect 13: A method for wireless communications at a network entity, comprising: outputting a plurality of SSBs over a plurality of respective transmission beams, each SSB corresponding to at least one respective energy transfer resource of a plurality of energy transfer resources according to a mapping between the plurality of SSBs and the plurality of energy transfer resources; and outputting one or more energy transfer signals on a set of one or more energy transfer resources, the set of one or more energy transfer resources corresponding to a first SSB of the plurality of SSBs according to the mapping.

Aspect 14: The method of aspect 13, further comprising: outputting the one or more energy transfer signals using a transmission beam that is associated with the set of one or more energy transfer resources according to a further mapping between the transmission beam and the set of one or more energy transfer resources, wherein the transmission beam is not associated with a first transmission beam of the plurality of transmission beams corresponding to the first SSB.

Aspect 15: The method of any of aspects 13 through 14, further comprising: outputting the one or more energy transfer signals using a first transmission beam of the plurality of transmission beams that is associated with the set of one or more energy transfer resources according to a further mapping between the first transmission beam and the set of one or more energy transfer resources, wherein the first SSB is output using the first transmission beam.

Aspect 16: The method of aspect 15, further comprising: outputting an indication that a UE refrain from transmitting a measurement report associated with the one or more energy transfer signals, wherein the one or more energy transfer signals comprise reference signals that are quasi co-located with a transmission beam of the plurality of respective transmission beams that is associated with the first SSB.

Aspect 17: The method of any of aspects 13 through 16, wherein each subset of a plurality of subsets of the set of one or more energy transfer resources is associated with a respective energy transfer type of a plurality of energy transfer types.

Aspect 18: The method of any of aspects 13 through 17, wherein each subset of a plurality of subsets of the set of one or more energy transfer resources is associated with a respective energy transfer charging rate.

Aspect 19: The method of any of aspects 13 through 18, wherein each subset of a plurality of subsets of the set of one or more energy transfer resources is associated with a respective type of energy harvesting, a respective set of frequency resources, a respective periodicity, a respective UE power setting, or any combination thereof.

Aspect 20: The method of any of aspects 13 through 19, further comprising: outputting system information, master information, or a random access message, comprising an indication of the mapping.

Aspect 21: The method of any of aspects 13 through 20, wherein the set of one or more energy transfer resources are associated with a first set of frequency resources, further comprising: outputting control signaling indicating a second set of frequency resource associated with a second set of one or more energy transfer resources.

Aspect 22: The method of any of aspects 13 through 21, further comprising: outputting an indication of a second set of one or more energy transfer resources, wherein the set of one or more energy transfer resources is associated with a first set of transmission beams and the second set of one or more energy transfer resources are associated with a second set of transmission beams, and wherein the second set of transmission beams are more narrow than the first set of transmission beams; and outputting one or more additional energy transfer signals using the second set of one or more energy transfer resources over the second set of transmission beams.

Aspect 23: The method of any of aspects 13 through 22, further comprising: outputting an indication of one or more parameters associated with the one or more energy transfer signals; and outputting data signaling on at least a portion of the set of one or more energy transfer resources based at least in part on outputting the indication of the one or more parameters.

Aspect 24: An apparatus for wireless communications at a UE, comprising at least one processor; memory coupled with the at least one processor; and instructions stored in the memory and executable by the at least one processor to cause the apparatus to perform a method of any of aspects 1 through 12.

Aspect 25: An apparatus for wireless communications at a UE, comprising at least one means for performing a method of any of aspects 1 through 12.

Aspect 26: A non-transitory computer-readable medium storing code for wireless communications at a UE, the code comprising instructions executable by at least one processor to perform a method of any of aspects 1 through 12.

Aspect 27: An apparatus for wireless communications at a network entity, comprising at least a processor; memory coupled with the at least one processor; and instructions stored in the memory and executable by the at least one processor to cause the apparatus to perform a method of any of aspects 13 through 23.

Aspect 28: An apparatus for wireless communications at a network entity, comprising at least one means for performing a method of any of aspects 13 through 23.

Aspect 29: A non-transitory computer-readable medium storing code for wireless communications at a network entity, the code comprising instructions executable by at least one processor to perform a method of any of aspects 13 through 23.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies, including future systems and radio technologies, not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, etc., whether referred to as software, firmware, middleware, microcode, hardware description language, or otherwise. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (e.g., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” encompasses a variety of actions and, therefore, “determining” can include calculating, computing, processing, deriving, investigating, looking up (such as via looking up in a table, a database or another data structure), or ascertaining. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
at least one processor; and
memory coupled to the at least one processor, the memory storing instructions executable by the at least on processor to cause the UE to:
receive a plurality of synchronization signal blocks over a plurality of respective transmission beams, each synchronization signal block corresponding to at least one respective energy transfer resource of a plurality of energy transfer resources according to a mapping between the plurality of synchronization signal blocks and the plurality of energy transfer resources;
monitor a set of one or more energy transfer resources for one or more energy transfer signals, the set of one or more energy transfer resources corresponding to a first synchronization signal block of the plurality of synchronization signal blocks according to the mapping; and
perform energy harvesting using the one or more energy transfer signals.

2. The apparatus of claim 1, wherein the instructions are further executable by the at least one processor to cause the UE to:
receive, based at least in part on the monitoring, the one or more energy transfer signals using a spatial filter that is associated with the set of one or more energy transfer resources according to a further mapping between the spatial filter and the set of one or more energy transfer resources, wherein the spatial filter is not associated with a first transmission beam corresponding to the first synchronization signal block.

3. The apparatus of claim 1, wherein the instructions are further executable by the at least one processor to cause the UE to:
receive, based at least in part on the monitoring, the one or more energy transfer signals using a spatial filter that is associated with a first transmission beam corresponding to the first synchronization signal block according to a further mapping between the first transmission beam corresponding to the first synchronization signal block and the set of one or more energy transfer resources.

4. The apparatus of claim 3, wherein the instructions are further executable by the at least one processor to cause the UE to:
receive an indication that the UE refrain from transmitting a measurement report associated with the one or more energy transfer signals, wherein the one or more energy transfer signals comprise reference signals that are quasi co-located with a transmission beam of the plurality of respective transmission beams that is associated with the first synchronization signal block.

5. The apparatus of claim 1, wherein the instructions are further executable by the at least one processor to cause the UE to:
select a first subset of the set of one or more energy transfer resources based at least in part on an energy transfer type of the UE, wherein each subset of a plurality of subsets of the set of one or more energy transfer resources is associated with a respective energy transfer type of a plurality of energy transfer types.

6. The apparatus of claim 5, wherein each subset of the plurality of subsets of the set of one or more energy transfer resources is associated with a respective energy transfer charging rate.

7. The apparatus of claim 5, wherein each subset of the plurality of subsets of the set of one or more energy transfer resources is associated with a respective type of energy harvesting, a respective set of frequency resources, a respective periodicity, a respective UE power setting, or any combination thereof.

8. The apparatus of claim 1, wherein the instructions are further executable by the at least one processor to cause the UE to:
receive system information, master information, or a random access message, comprising an indication of the mapping.

9. The apparatus of claim 1, wherein the set of one or more energy transfer resources are associated with a first set of frequency resources, and wherein the instructions are further executable by the at least one processor to cause the UE to:
receive control signaling indicating a second set of frequency resource associated with a second set of one or more energy transfer resources.

10. The apparatus of claim 9, wherein the instructions are further executable by the at least one processor to cause the UE to:
tune energy harvesting circuitry at the UE to the first set of frequency resources associated with the set of one or more energy transfer resources, wherein performing the energy harvesting is based at least in part on the tuning; and
retune to the second set of one or more energy transfer resources according to the control signaling.

11. The apparatus of claim 1, wherein the instructions are further executable by the at least one processor to cause the UE to:
receive an indication of a second set of one or more energy transfer resources, wherein the set of one or more energy transfer resources is associated with a first set of transmission beams and the second set of one or more energy transfer resources are associated with a second set of transmission beams, and wherein the second set of transmission beams are more narrow than the first set of transmission beams;
monitor for one or more additional energy transfer signals using the second set of one or more energy transfer resources over the second set of transmission beams; and
perform energy harvesting using the one or more additional energy transfer signals.

12. The apparatus of claim 1, wherein the instructions are further executable by the at least one processor to cause the UE to:
receive an indication of one or more parameters associated with the one or more energy transfer signals;
monitor for data transmissions during at least a portion of the set of one or more energy transfer resources;
cancel the one or more energy transfer signals based at least in part on the one or more parameters; and
decode the data transmissions based at least in part on the canceling.

13. An apparatus for wireless communications at a network entity, comprising:
at least one processor; and
memory coupled to the at least one processor, the memory storing instructions executable by the at least one processor to cause the network entity to:
output a plurality of synchronization signal blocks over a plurality of respective transmission beams, each synchronization signal block corresponding to at least one respective energy transfer resource of a plurality of energy transfer resources according to a mapping between the plurality of synchronization signal blocks and the plurality of energy transfer resources; and
output one or more energy transfer signals on a set of one or more energy transfer resources, the set of one or more energy transfer resources corresponding to a first synchronization signal block of the plurality of synchronization signal blocks according to the mapping.

14. The apparatus of claim 13, wherein the instructions are further executable by the at least one processor to cause the network entity to:
output the one or more energy transfer signals using a transmission beam that is associated with the set of one or more energy transfer resources according to a further mapping between the transmission beam and the set of one or more energy transfer resources, wherein the transmission beam is not associated with a first transmission beam of the plurality of transmission beams corresponding to the first synchronization signal block.

15. The apparatus of claim 13, wherein the instructions are further executable by the at least one processor to cause the network entity to:
output the one or more energy transfer signals using a first transmission beam of the plurality of transmission beams that is associated with the set of one or more energy transfer resources according to a further mapping between the first transmission beam and the set of one or more energy transfer resources, wherein the first synchronization signal block is output using the first transmission beam.

16. The apparatus of claim 15, wherein the instructions are further executable by the at least one processor to cause the network entity to:
output an indication that a user equipment (UE) refrain from transmitting a measurement report associated with the one or more energy transfer signals, wherein the one or more energy transfer signals comprise reference signals that are quasi co-located with a transmission beam of the plurality of respective transmission beams that is associated with the first synchronization signal block.

17. The apparatus of claim 13, wherein each subset of a plurality of subsets of the set of one or more energy transfer resources is associated with a respective energy transfer type of a plurality of energy transfer types.

18. The apparatus of claim 13, wherein each subset of a plurality of subsets of the set of one or more energy transfer resources is associated with a respective energy transfer charging rate.

19. The apparatus of claim 13, wherein each subset of a plurality of subsets of the set of one or more energy transfer resources is associated with a respective type of energy harvesting, a respective set of frequency resources, a respective periodicity, a respective UE power setting, or any combination thereof.

20. The apparatus of claim 13, wherein the instructions are further executable by the at least one processor to cause the network entity to:
output system information, master information, or a random access message, comprising an indication of the mapping.

21. The apparatus of claim 13, wherein the instructions are further executable by the at least one processor to cause the network entity to:
output control signaling indicating a second set of frequency resource associated with a second set of one or more energy transfer resources.

22. The apparatus of claim 13, wherein the instructions are further executable by the at least one processor to cause the network entity to:
output an indication of a second set of one or more energy transfer resources, wherein the set of one or more energy transfer resources is associated with a first set of transmission beams and the second set of one or more energy transfer resources are associated with a second set of transmission beams, and wherein the second set of transmission beams are more narrow than the first set of transmission beams; and
output one or more additional energy transfer signals using the second set of one or more energy transfer resources over the second set of transmission beams.

23. The apparatus of claim 13, wherein the instructions are further executable by the at least one processor to cause the network entity to:
output an indication of one or more parameters associated with the one or more energy transfer signals; and
output data signaling on at least a portion of the set of one or more energy transfer resources based at least in part on outputting the indication of the one or more parameters.

24. A method for wireless communications at a user equipment (UE), comprising:
receiving a plurality of synchronization signal blocks over a plurality of respective transmission beams, each synchronization signal block corresponding to at least one respective energy transfer resource of a plurality of energy transfer resources according to a mapping between the plurality of synchronization signal blocks and the plurality of energy transfer resources;
monitoring a set of one or more energy transfer resources for one or more energy transfer signals, the set of one or more energy transfer resources corresponding to a first synchronization signal block of the plurality of synchronization signal blocks according to the mapping; and
performing energy harvesting using the one or more energy transfer signals.

25. The method of claim 24, further comprising:
receiving, based at least in part on the monitoring, the one or more energy transfer signals using a spatial filter that is associated with the set of one or more energy transfer resources according to a further mapping between the spatial filter and the set of one or more energy transfer resources, wherein the spatial filter is not associated with a first transmission beam corresponding to the first synchronization signal block.

26. The method of claim 24, further comprising:
receiving, based at least in part on the monitoring, the one or more energy transfer signals using a spatial filter that is associated with a first transmission beam corresponding to the first synchronization signal block according to a further mapping between the first transmission beam corresponding to the first synchronization signal block and the set of one or more energy transfer resources.

27. The method of claim 24, further comprising:
selecting a first subset of the set of one or more energy transfer resources based at least in part on an energy transfer type of the UE, wherein each subset of a plurality of subsets of the set of one or more energy transfer resources is associated with a respective energy transfer type of a plurality of energy transfer types.

28. The method of claim 24, further comprising:
receiving system information, master information, or a random access message, comprising an indication of the mapping.

29. The method of claim 24, wherein the set of one or more energy transfer resources are associated with a first set of frequency resources, further comprising:
receiving control signaling indicating a second set of frequency resource associated with a second set of one or more energy transfer resources.

30. A method for wireless communications at a network entity, comprising:
outputting a plurality of synchronization signal blocks over a plurality of respective transmission beams, each synchronization signal block corresponding to at least one respective energy transfer resource of a plurality of energy transfer resources according to a mapping between the plurality of synchronization signal blocks and the plurality of energy transfer resources; and
outputting one or more energy transfer signals on a set of one or more energy transfer resources, the set of one or more energy transfer resources corresponding to a first synchronization signal block of the plurality of synchronization signal blocks according to the mapping.
